(19) United States
(12) Patent Application Publication
(10) Pub. No.: US 2011/0109544 A1
(43) Pub. Date: May 12, 2011

(54) Display control device for remote control device

(75) Inventors: Nozomi Kitagawa, Okazaki-city (JP); Takeshi Haruyama, Kariya-city (JP); Tetsuya Enokizaka, Nagoya-city (JP); Shouichirou Hanai, Anjo-city (JP); Shinji Hatanaka, Okazaki-city (JP)

(73) Assignees: DENSO CORPORATION, Kariya-city (JP); NIPPON SOKEN, INC., Nishio-city (JP)

(21) Appl. No.: 12/923,969

(22) Filed: Oct. 19, 2010

(30) Foreign Application Priority Data
Nov. 9, 2009 (JP) 2009-256464

(51) Int. Cl. G06F 3/033

(52) U.S. Cl. 345/157

(57) ABSTRACT

A display control device for a remote control device is disclosed. The display control device is connected with a display device for displaying an operation screen having multiple icons and a remote control device spaced apart form the display device. The display control device performs display control in the following way. The display control device displays an identification display mark in association with one icon in a selection state. When an instruction of an operation direction is inputted, the display control device displays a visual presentation indicative of the operation direction on the operation screen by making a change in display manner of the identification display mark, with the identification display mark being displayed in association with the one icon in the selection state.

### CROSS REFERENCE TO RELATED APPLICATION

The present application is based on Japanese Patent Application No. 2009-256464 on Nov. 9, 2009, disclosure of which is incorporated herein by reference.

### BACKGROUND OF THE INVENTION

1. Field of the Invention

The present invention relates to a remote control system that includes a display device and a remote control device spaced apart from each other. The display device is configured to display an operation screen for an input of an instruction directed to a control target apparatus. The remote control device is manipulatable by a user in order to point at position on the operation screen and to input the instruction.

2. Description of Related Art

There is known a remote control system for operating an in-vehicle apparatus, e.g., a navigation apparatus, an air conditioner, an audio apparatus and the like, via pointing at a certain position on an operation screen displayed on a display device such as a liquid crystal display device and the like. For this type of remote control systems, because of the need for reduction of movement of viewpoint of a driver in driving, it may be preferable that the display device for displaying the operation screen be located as far as possible in front of the driver. Since the remote control device is manipulated in order to point at position on the operation screen, it may be preferable that the remote control device be located within driver's reach, and the driver can manipulate the remote control device without taking a look at a manipulation member of the remote control device.

For example, a remote control system described in JP-A-2006-29917 includes a display device configured to display an operation screen and a manipulation member configured to be manipulatable by a user. The display device and the manipulation member are spaced apart from each other. The remote control system described in JP-A-2006-29917 employs the following operation method (see FIGS. 9(a) and 9(d) of JP-A-2006-29917). A pointer continuously indicates a pointed position (i.e., a position pointed by a pointer) on the operation screen. The pointer is operated using the remote control device, and is moved onto an icon to which an instruction directed to an in-vehicle apparatus is assigned. The instruction is issued via selection of the icon. According to the above operation method however, it takes an effort and a time to move the pointer onto a desired position on the operation screen. A period of time for a user to gaze the operation screen is increased, resulting in troublesome.

The inventors of the present application have studied a method for selecting an icon from among multiple icons without displaying a pointer. Discussion will be given below on a method for selecting an icon without displaying a pointer.

The method may be as follows. An operation screen containing multiple icons is displayed. An identification display mark such as a cursor and the like is displayed in association with an icon that is presently in a selection state, i.e., that is presently selected. When an instruction about an operation direction indicative of a certain direction is inputted, the cursor and the selection state are moved to a destination icon, which is for example an icon located closest to the position of the icon in the selection state in the operation direction. According to this method, it is possible to omit an effort of moving the pointer onto position of the destination icon from user operation. Moreover, it is possible reduce a time for a user to gaze the operation screen, and it is possible reduce user's operation burden.

According to the above method, the un-display of a pointer leads to the reduction of the user's operation burden. At the same time, since the cursor is moved to a destination icon when an operation amount of the operation direction becomes a predetermined operation amount or more and satisfies a cursor movement condition, the following difficulty can arise. During a period between a time when the input of the operation direction is started and a time when the cursor is actually moved to a destination icon due to the satisfaction of the cursor movement condition, the user cannot catch in which direction the cursor is about to move in response to his or her operation. This is because the elimination of a pointer from display results in a situation where there is no display mark that continuously traces or tracks a result of user's instruction about the operation direction. As a result, if the user's intended operation direction is different from an actual operation direction inputted via the remote control device, the user can be aware of his or her wrong operation after the cursor is moved in a direction different from the user's intended direction. As can be seen from the above, a user is difficult to be aware of his or her wrong operation.

### SUMMARY OF THE INVENTION

In view of the above and other difficulties, it is an objective of the present invention to provide a display control device for a remote control device, the display control device being capable of improving operability of the remote control device by displaying a visual presentation in association with an icon to indicate the presently-inputted operation direction.

According to a first aspect of the present invention, a display control device for a remote control device includes a connection means and a display control means. The connection means is connected with a display device and a remote control device. The display device is configured to display an operation screen for accepting an operation directed to a control target apparatus. Multiple icons are arranged on the operation screen. The remote control device is spaced apart from the display device and is manipulatable by a user. The display control means is configured to perform display control in manners including the followings. The display control means receives an input of an instruction about an operation direction from the remote control device, performs processing according to the input, and causes the display device to display a result of the processing on the operation screen according to the input. The display control means displays an identification display mark on the operation screen, so that (i) the identification display mark indicates that one icon of the multiple icons, the one icon being presently selected, is in a selection state and (ii) the identification display mark is displayed in association with the one icon in the selection state. When the display control means receives the input of the instruction about the operation direction while the one icon is being in the selection state, the display control means displays a visual presentation indicative of the operation direction on the operation screen by making a change in display manner of the identification display mark, with the identification display mark being displayed in association with the one icon in the selection state. When an operation amount of the operation direction reaches a condition for moving the selection state from the one icon, the display control means stops the one icon from being in the selection state and stops displaying the identification display mark in association with the one icon.

According to the above display control device, before the selection state is shifted from the one icon to a destination icon, it is possible to visually inform to a user in which direction the selection state is about to be shifted in accordance with the input of the instruction about the operation direction. As a result, a user can recognize in which direction the identification display mark (e.g., cursor) is about to move in response to his or her manipulation on the remote control device. Operability of the remote control device is improved. Even if the inputted operation direction is different from a user's intended direction, a user can be aware of his or her wrong operation through recognizing the change in display manner of the identification display mark before the selection state is shifted to an unintended icon. Thus, a user can promptly correct his or her operation. Moreover, unlike a pointer which is continuously displayed to continuously track or trace a result of a user's manipulation for the input of the operation direction, the visual presentation indicative of the operation direction is displayed in the vicinity of the one icon in the selection state only when the instruction of the operation direction is inputted. Therefore, it is possible to reduce a time for user to gaze the operation screen and a user's operation burden, as compared to the pointer.

According to a second aspect of the present invention, a display control device for a remote control device includes a connection means and a display control means. The connection means has connection with a display device and a remote control device. The display device is configured to display an operation screen for accepting an operation directed to a control target apparatus. Multiple icons are arranged on the operation screen. The remote control device is spaced apart from the display device and is manipulatable by a user. The display control means is configured to perform display control in manners including the followings. The display control means receives an input of an instruction about an operation direction from the remote control device, performs processing according to the input, and causes the display device to display a result of the processing on the operation screen according to the input. The display control means displays an identification display mark on the operation screen, so that (i), the identification display mark indicates that one icon of the multiple icons, the one icon being presently selected, is in a selection state and (ii) the identification display mark is displayed in association with the one icon in the selection state. When the display control means receives the input of the instruction about the operation direction while the one icon is being in the selection state, the display control means displays a guidance display mark indicative of a destination icon on the operation screen, so that (i) the destination icon is assigned as another one icon of the plurality of icons to correspond to the operation direction from the one icon in the selection state and (ii) the guidance display mark is displayed in association with the destination icon. When an operation amount of the inputted operation direction reaches a condition for moving the identification display mark from the one icon to the destination icon, the display controls means shifts the selection state from the one icon to the destination icon and shifts a display target of the identification display mark from the one icon to the destination icon.

According to the above display control device, before the selection state is shifted from the one icon to the destination icon, it is possible to use the guidance display mark in order to visually inform to a user in which direction the selection state is about to be shifted in accordance with the input of the instruction about the operation direction. As a result, a user can recognize in which direction the identification display mark (e.g., cursor) is about to move in response to his or her manipulation on the remote control device. Operability of the remote control device is improved. Even if the inputted operation direction is different from a user's intended direction, a user can be aware of his or her wrong operation through recognizing the change in display manner of the guidance display mark before the selection state is shifted to an unintended icon. Thus, a user can promptly correct his or her operation. Moreover, unlike a pointer which is continuously displayed to continuously track or trace a result of a user's manipulation for the input of the operation direction, the guidance display mark indicative of the destination icon is displayed in the vicinity of the destination icon only when the instruction about the operation direction is inputted. Therefore, it is possible to reduce a time for user to gaze the operation screen and a user's operation burden, as compared to the pointer.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a remote control system;

FIG. 2 is a diagram illustrating an arrangement of a display device and a manipulation device;

FIG. 3 is a diagram illustrating one example of an operation screen displayed on a display device;

FIG. 4 is a flowchart illustrating a procedure of operation direction displaying processes;

FIG. 5 is a diagram for explanation on a reference position of an icon and a deviation Δp of a control pointer;

FIG. 6 is a diagram illustrating movement of a cursor through time when operation direction is changed;

FIGS. 7A, 7B, 7C, 8 and 9 are diagrams each illustrating an example of modification of a visual presentation indicative of an operation direction;

FIGS. 10A and 10B are diagrams each illustrating a case where a visual presentation indicative of an operation direction is displayed in association with a destination icon.

### DETAILED DESCRIPTION OF EMBODIMENTS

Embodiments of the present invention will be described below with reference to the accompanying drawings. In should be noted that embodiments of the present invention are not limited to the below-described embodiments. Embodiments of the present invention can have various forms.

(Configuration of Remote Control System)

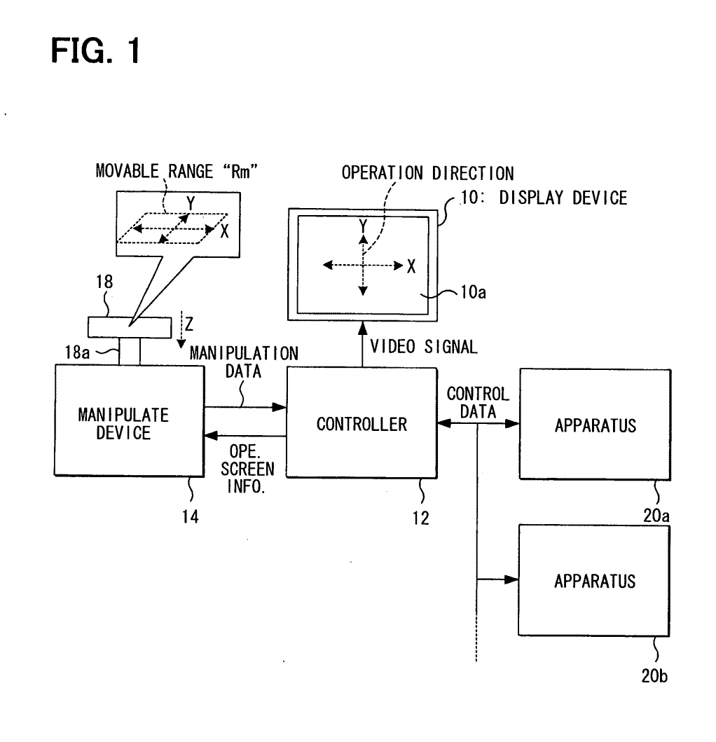

FIG. 1 is a block diagram illustrating a remote control system according to one embodiment.

The remote control system can be used for operation on an apparatus mounted to, for example, a vehicle. As shown in FIG. 1, the remote control system includes a display device 10, a controller 12, a manipulation device 14, and an apparatus 20. The display device 10 includes a display panel 10a (e.g., a liquid crystal display panel) for displaying thereon an image. The controller 12 controls components of the remote control system. The manipulation device 14 is manipulatable by a user. The apparatus 20 is a control target apparatus, which may include a first in-vehicle apparatus 20a and a second in-vehicle apparatus 20a. The controller 12 and the manipulation device 14 are connected with each other and communicatable with each other via a dedicated communication line. Via this dedicated communication line, information on an operation screen is transmitted from the controller 12 to the manipulation device 14, and manipulation data is transmitted from the manipulation device 14 to the controller 12. The controller 12 and the apparatuses 20a, 20b are connected with other and communicable with each other via an in-vehicle LAN. Via this in-vehicle LAN, various data on control of each apparatus 20a, 20b is transmittable and receivable. The controller 12 and the display device 10 are connected with each other via a video line. The controller 12 transmits a video signal including a signal relating to an operation screen to the display device 10. The controller 12 can act as a display control means or section, and a connection means or section.

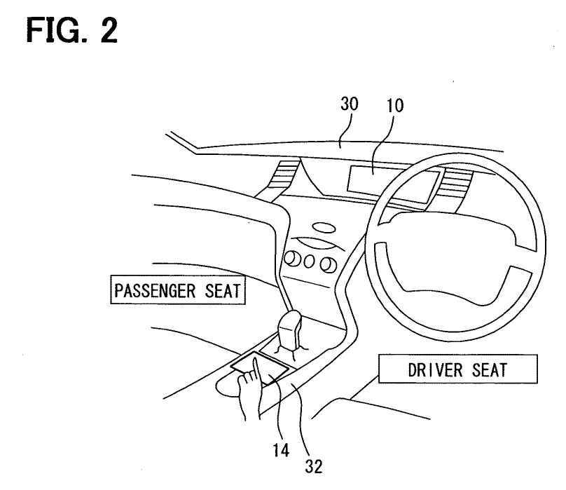

As shown in FIG. 2, the display device 10 and the manipulation device 14 are disposed in a vehicle compartment. The display device 10 is disposed on a dashboard, which is located forward of a driver. More specifically, the display device 10 is located approximately at a middle of dashboard 30 between a driver seat and a front passenger seat. This arrangement of the display device 10 can reduce movement of viewpoint of a driver when the driver takes a look at the display panel 10a of the display device 10. The manipulation device 14 is arranged on an upper surface of a center console 32 located directly lateral to the driver seat. This arrangement of the manipulation device 14 enables a driver to easily manipulate the manipulation device without reaching up his or her hand to a distant or without changing his or her position.

Description now returns to the block diagram of FIG. 1.

The manipulation device 14 includes a manipulation knob 18, which is movable in response to user manipulation thereon. A user may be a driver or a front passenger of the vehicle. The manipulation knob 18 includes an axis part 18a. The manipulation knob 18 is movable in two dimensional directions, i.e., in a frontward direction, in a backward direction, a rightward direction and a leftward direction, while an lower end of the axis part 18a is acting as a pivot point. That is, the manipulation knob 18 can act as a manipulation lever. The manipulation knob 18 returns to a predetermination position, i.e., neutral position, when the manipulation knob 18 is not subjected to an external force from a user in the two dimension directions. The manipulation device 14 is operable in a relative input mode, in which the pointed position on the operation screen is determined in a relative manner based on an amount of manipulation on the manipulation device 14. The amount of manipulation is for example associated with inclination of the manipulation knob 18 with respect to the neutral position, a force applied to the manipulation knob 18, an input time (e.g., input duration time) etc. The amount of manipulation can determine an operation amount of an operation direction.

In the present embodiment, the manipulation knob 18 has a movable range “Rm” in the two-dimension directions. For illustrative purpose, one manipulation direction in the movable range Rm that corresponds to a lateral operation direction (i.e., horizontal direction) on the display panel 10a is defined as an X axis direction or a left-right direction. Another manipulation direction in the movable range Rm that corresponds to a longitudinal operation direction (i.e., vertical direction) on the display panel 10a is defined as a Y axis direction or a front-rear direction. The manipulation knob 18 is further movable in a direction parallel to the axis of the manipulation knob 18 (see the arrow “Z” in FIG. 1). That is, the manipulation knob 18 is further movable along a Z axis direction. When the manipulation knob 18 is not subjected a force in the Z axis direction, the manipulation knob 18 returns to a predetermined position so that the manipulation knob 18 is located at an upper position along the axis of the manipulation knob 18. The manipulation device 14 further includes a manipulation direction detection sensor (not shown) for detecting inclination of the manipulation knob 18 toward the X axis direction and the Y axis direction, a pressing operation detection sensor (not shown) for detecting the pressing of the manipulation knob 18 in the Z axis direction, a response force generation unit (not shown) and the like. The response force generation unit supports the axis part 18a of the manipulation knob 18, and applies a response force (e.g., a resistance force) and a vibration force to the axis part 18a. A direction of the resistance force may be opposite to a direction of a manipulation force, which is applied to the manipulation knob 18 in the X direction and the Y direction.

The manipulation device 14 transmits the manipulation data to the controller 12. The manipulation data includes a result of detection by a manipulation direction detection sensor and the pressing manipulation detection sensor. Based on the information on an operation screen inputted from the controller 12, the force generation unit of the manipulation device 14 generates the response force or the vibration force according to a situation of the manipulation of the manipulation device 14 and a situation of the arrangement of icons on the operation screen. Accordingly, a user can get a resistance force or a click feeling via the manipulation knob 18 according to the situation of the manipulation of the manipulation knob 18 and the situation of the arrangement of icons. The manipulation device 14 can act as a remote control device.

The controller 12 includes a microcomputer unit for control of the remote control system. The microcomputer unit includes a central processing unit (CPU), a read-only memory (ROM), a random access memory (RAM), and a communication interface, each of which is not shown in the drawings. The controller 12 causes the display device 10 to display an operation screen, which constitutes GUI (Graphical User Interface) directed to the control target apparatus 20, e.g., the apparatuses 20a, 20b. Then, when a user selects one of various icon on the operation screen and issues an instruction of execution of a function assigned to the selected icon, the controller 12 accepts the instruction of execution of the function assigned to the selected icon and causes the control target apparatus 20 (e.g., the apparatus 20a, 20b) to execute the function assigned to the selected icon. The controller 12 can act as a display control device for a remote control device, which display control device including a display control means or section and a connection means or section.

Each apparatus 20a, 20b is an operation target of the remote control system. For example, the apparatus 20a or 20b, may be an air conditioner, an audio visual player, a car navigation apparatus or the like. In one embodiment, two in-vehicle apparatuses 20a and 20b are connected to the remote control system. Alternatively, more than two apparatuses or one apparatus may be the operation target of the remote control system.

Although the configuration of the remote control system is described above in accordance with one embodiment, the remote control system is not limited to having the above-described configuration. The remote control system can have various configurations.

For example, although the manipulation device 14 is operable in the relative input mode in the above-described example, the manipulation device 14 may be operable in an absolute input mode in place of or in addition to the relative input mode. In the absolute input mode, a coordinate system is set on a predetermined region (e.g., operation target region) of the operation screen. A coordinate system is also set on the movable range of the manipulation knob 18 in the two dimension directions. The coordinate system of the operation screen has one-to-one correspondence to the coordinate system of the movable range of the manipulation knob 18. A coordinate on the operation target region of the operation screen corresponding to the coordinate of the position of the manipulation knob 18 is determined as a pointed position on the operation screen.

In the above example configuration, the manipulation device 14 and the controller 12 are connected with each other via the dedicated line. Alternatively, like other components are, the manipulation device 14 may be connected with the controller 12 via the in-vehicle LAN.

Alternatively, the controller 12 may be a built-in component of the apparatus 20a, 20b.

(Operation of Remote Control System)

Explanation will be given below on processes that are performed by the controller 12 in connection with operation for selecting an icon on an operation screen. More detailed examples of the processes will be given later.

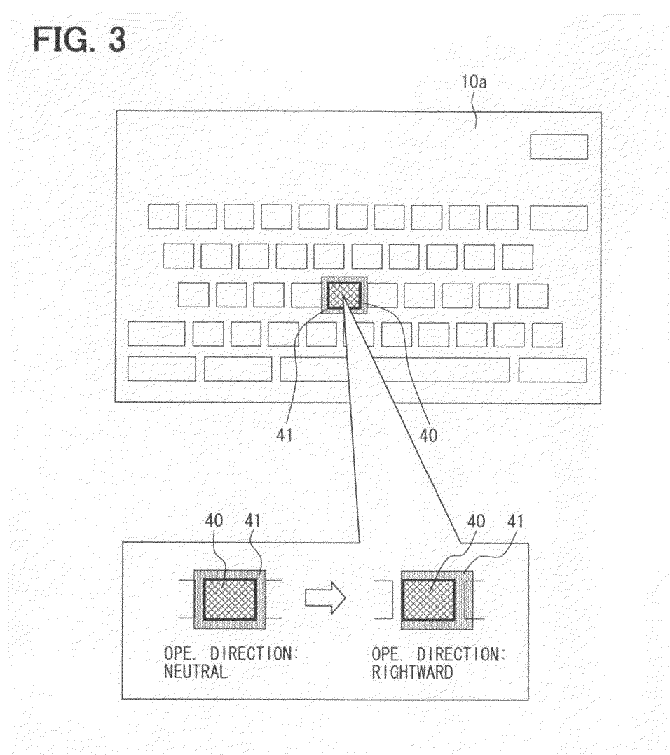

FIG. 3 illustrates an example of the operation screen, which the controller 12 displays on the display panel 10a of the display device 10. The operation screen illustrated in FIG. 3 has thereon multiple icons to which predetermined functions are respectively assigned. The multiple icons are arranged into a layout like a typical keyboard layout of a PC (personal computer). Among the multiple icons, one icon 40 is in selection state. A cursor 41 is displayed on the background of the one icon 40, so that the cursor 41 is similar in shape to the icon 40 and has a larger size than the icon 40. The cursor 41 acts as an identification display mark for showing to a user that the icon 40 is in the selection state. Because of the cursor 41, the icon 40 in the selection state is visually distinguishable from other icons in the non-selection state. Other than the use of the cursor 41, there may be alternative ways to visually distinguish the icon 40 in the selection state from other icons in the non-selection state. For example, the icon 40 in the selection may be highlighted by a change in display manner (e.g., color, brightness). It should be noted that a conventional pointer, which is continuously displayed to visually trace or track the pointed position on the operation screen, is not displayed on the operation screen provided by the remote control system of the present embodiment. In the present embodiment, the cursor 41, which is displayed in association with the icon 40 in the selection state, is used in place of the conventional pointer. From the cursor 41, a user can be aware of the present pointed position.

When the manipulation knob 18 of the manipulation device 14 is pressed in the Z axis direction while one icon is being in the selection state on the operation screen, an instruction of execution of a function assigned to the one icon in the selection state is issued to a corresponding one of the apparatuses 20a, 20b, or alternatively, an instruction directed to the remote control system may be issued.

Herein, the pressing of the manipulation knob 18 in the Z axis direction may be referred to as a setting manipulation. When one icon is in the selection state and when the manipulation knob 18 of the manipulation device 14 is inclined in the X axis direction, the Y axis direction, or an oblique direction between the X axis direction and the Y axis direction to input an instruction about an operation direction, it is determined whether an operation amount of the operation direction reaches a predetermined movement condition. When the operation amount of the operation direction reaches the predetermined movement condition, the selection state is shifted from the position of the selected one icon to a destination icon, which is an icon located in a direction corresponding to the operation direction relative to the one icon. When the selection state is shifted to the destination icon, a display target of the cursor 41 is changed to the destination icon so that the cursor 41 is displayed in association with the destination icon.

In the above case, the controller 12 displays a visual presentation on the operation screen during a period from (i) a time when an input of the instruction about the operation direction is started in response to the manipulation on the manipulation knob 18 of the manipulation device 14 to (ii) a time when the selection state is actually shifted to the destination icon. For example, the controller 12 displays the displayed visual presentation on the operation screen by moving the cursor 41 in the operation direction based on the manipulation data inputted from the manipulation device 14.

More specifically, when the manipulation knob 18 is in a given state (e.g., a natural state regarding the operation direction), the cursor 41 is fixedly displayed at the icon 40 in the selection state so that the cursor 41 and the icon 40 are concentric. When the input of the instruction about the operation direction indicates that the operation direction is rightward and when an operation amount of the operation direction is moderate, the cursor 41 is moved rightward in accordance with the inputted operation direction. Here, the moderate operation amount is a level of an operation amount that does not reach the predetermined movement condition. It should be noted that when an amount of the manipulation on the manipulation knob 18 reaches a predetermined amount, the level of inputted the operation amount reaches the predetermined movement condition, and the selection state is shifted from the position of the selected one icon to the destination icon corresponding to the operation direction. In other words, the moderate operation amount corresponds to an input situation where a user manipulates the manipulation knob 18 to an extent that the selection state is not shifted from the selected one icon to the destination icon.

A stage (2) shown in FIG. 3 illustrates a state where the operation amount of the operation direction is moderate and the cursor 41 is moved rightward in accordance with the operation direction. In contrast to a stage (1) shown in FIG. 3, it is visually and dynamically perceivable that the cursor 41 is moved rightward in accordance (i.e., conjunction) with the input from the manipulation knob 18.

Via the above visual presentation, a user can visually recognize in which direction the cursor 41 is about to move in response to his or her present manipulation. In the case shown in FIG. 3, the cursor 41 is displayed in association with the icon 40 so that the icon 40 and the cursor 41 overlap each other and the cursor 41 contains the entire icon 40. However, as long as a user can visually recognize the movement direction of the cursor 41, a display manner of the cursor 41 is not limited to the above-described example. A degree (e.g. area) to which the icon 40 and the cursor 41 overlaps each other may be arbitrary. For example, the icon 40 and the cursor 41 may partially overlap each other.

Upon starting manipulating the manipulation knob 18 to input the instruction about an operation direction, a user can confirm the followings by viewing a display situation, e.g., by viewing how the cursor 41 is moved relative to the icon 40. When an operation amount of the direction operation reaches the predetermined movement condition, another icon existing in the operation direction or a new icon displayed in the operation direction is put in the selection state, and the identification display mark is displayed on the display panel 10a in association with the another icon or the new icon. However, until an operation amount of the operation direction does not reach the predetermined movement condition, the another icon or the new icon is not put in the selection state. Therefore, when a user start inputting the instruction about an operation direction by manipulating the manipulation device 14, and when the user continue to manipulate the manipulation device 14 without changing the operation direction, the user can easily and accurately predict which one of the multiple icons is going to be put in the selection state before the operation amount reaches the predetermined movement condition.

(Explanation on Operation Direction Displaying Processes)

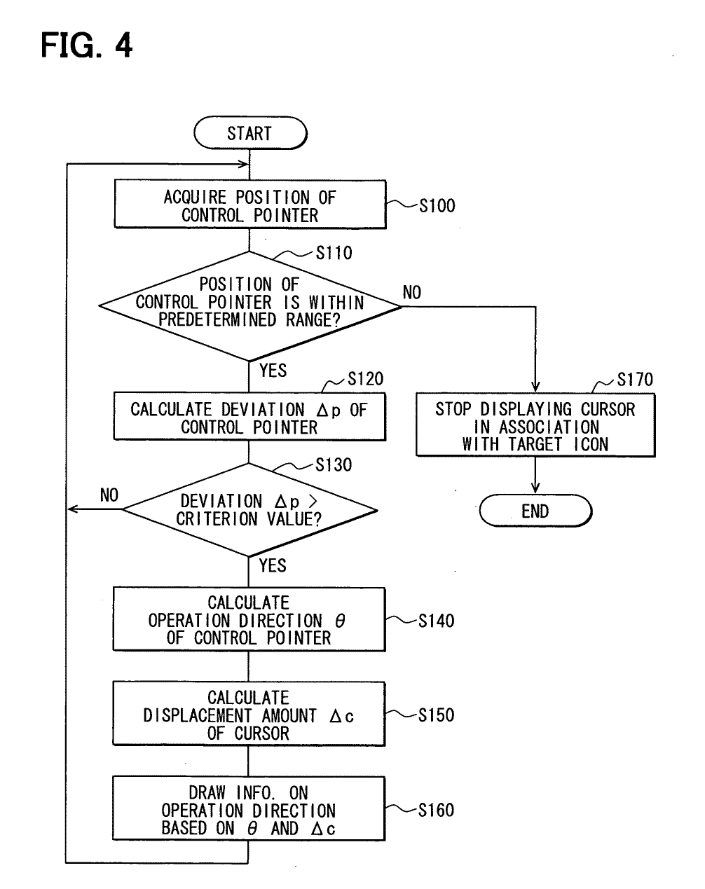

With reference to the flowchart of FIG. 4, explanation will be given on a procedure of processes (also referred to as operation direction displaying processes) for displaying information about an operation direction by using a cursor associated with an icon in the selection state. When an a icon is put in the selection state, the controller 12 performs the operation direction displaying processes so that the icon in the selection state is a target of the operation direction displaying processes.

At S100, the controller 12 acquires present position of a control pointer. Herein, the control pointer is a pointer prepared for use in internal processing of the controller 12, and comprises coordinate information, which indicates a coordinate of the present pointed position on the operation screen. When the manipulation knob 18 of the manipulation device 14 is in the neutral position, the position of the control pointer is set to a reference position (e.g., a center) of the icon in the selection state. When the manipulation device 14 is manipulated to input an instruction about an operation direction, the controller 12 receives the manipulation data including the instruction about the operation direction from the manipulation device 14 and changes the position of the control pointer based on the manipulation data. It should be noted that the control pointer does not displayed on the display device 10 and thus is invisible to a user.

Description returns to the flowchart of FIG. 4. At S110, the controller 12 determines whether the position of the control pointer is within a predetermined range (also referred to as a predetermined coordinate range) of the coordinate system of the operation screen. The predetermined range is assigned as corresponding to a position (or region) of the icon that is presently in the selection state on the operation screen. When the controller 12 determines that the position of the control pointer is within the predetermined coordinate range, the determination “YES” is made at S110 and the procedure proceeds to S120. At S120, the controller 12 calculates deviation Δp of the position of the control point from the reference position (e.g., a coordinate of the center of the icon in the selection state).

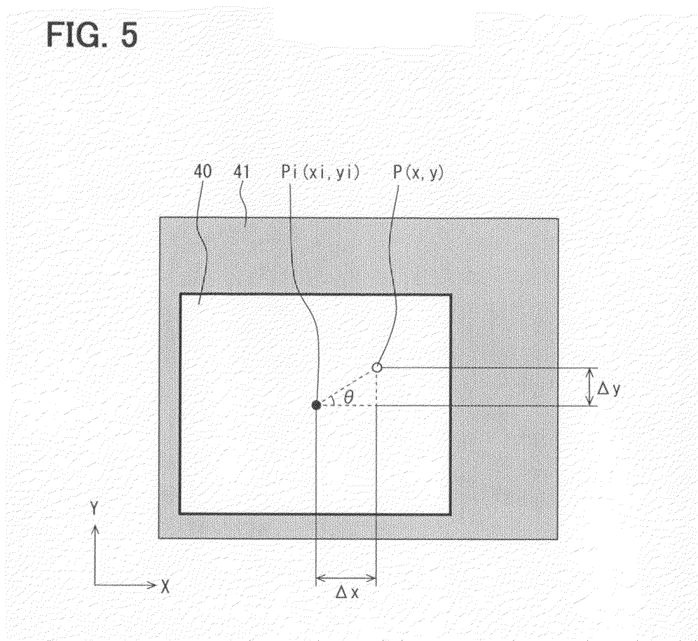

The deviation Δp to be calculated at S120 will be more specifically described with reference to FIG. 5. As shown in FIG. 5, the deviation Δp has an X axis direction component Δpx and a Y axis direction component Δpy. The X axis direction component Δpx is a X axis direction component of a distance between the position “P” of the control point, which is located inside the region of the icon 40, and the reference position “Pi”, which is set to a center of the icon in the selection state. The Y axis direction component Δy is a Y axis direction component of the distance between the position “P” of the control point and the reference position “Pi”. That is, when the coordinate of the reference position “Pi” of the icon 40 is denoted by (xi, yi) and when the position “P” of the control pointer is denoted by (x, y), the deviation Δpx, Δpy is calculated from the following equations:

Δpx=|Pi(xi)−P(x)|,

Δpy=|Pi(yi)−P(y)|.

Alternatively, a value of the distance between the reference position “Pi” of the icon 40 and the position “P” of the control pointer may be used as the deviation Δp in place of the deviation Δpx, Δpy.

Description returns to the flowchart of FIG. 4. After the calculation of the deviation Δp at S120, the procedure proceeds to S130. At S130, the controller 12 determines whether the deviation Δp is larger than a predetermined criterion value. More specifically, at S120, the deviation Δpx and the deviation Δpy are respectively compared with a first criterion value (e.g., Sx) pre-set for the deviation Δpx and a second criterion value (e.g., Sy) pre-set for the deviation Δpy. When at least one of the deviation Δpx and the deviation Δpy is lager than a corresponding one of the first criterion value and the second criterion value, the determination “YES” is made at S130. The criterion values to be compared with the deviations Δpx, Δpy may be set on an icon-by-icon basis. Alternatively, the criterion values to be compared with the deviations Δpx, Δpy may be calculated based on size of icons. These criterion values may be respectively set smaller than an X axis direction size and a Y axis direction size of the icon. When a value of the distance between the reference position “Pi” of an icon and the position “P” of the control pointer is used as the deviation “Δp”, the criterion value to be compared with the deviation “Δp” may have a single value for each icon.

When the controller 12 determines at S130 that the deviation Δp is less than or equal to the criterion value, the determination “NO” is made at S130 and the procedure returns to S100. In this case, the cursor associated with the icon in the selection state is maintained in a neutral state. In contrast, when the controller 12 determines at S130 that the deviation “Δp” is larger than the criterion value, the determination “YES” is made at S130, and the procedure proceeds to S140. At S140, the controller 12 calculates a value θ of the operation direction of the control pointer. As shown in FIG. 5, the value θ is an angle of a straight line connecting the reference position “Pi” of the icon and the position “P” of the control pointer with respect to the X axis. With use of the deviations Δpx, Δpy, the value θ is calculated from the following equation:

θ=tan⁻¹(Δy/Δx).

At S150, the controller 12 calculates a displacement amount Δc of the cursor from the reference position of a cursor based on the deviation Δp of the control pointer. More specifically, the controller 12 performs a predetermined calculation so that the displacement amount Δc of the cursor is calculated to be a larger value as the deviation Δp of the control pointer is larger. For example, the predetermined calculation may be the following calculation. The displacement amount Δc of the cursor is calculated to be proportional to the deviation Δp of the control pointer with a predetermined proportional factor, which is for example less than unity. Alternatively, the displacement amount Δc of the cursor may be calculated to be non-linearly related to the deviation Δp of the control pointer. When the displacement amount Δc of the cursor is a non-linear function of the deviation Δp of the control pointer, the displacement amount Δc of the cursor may be calculated in the following way. When the deviation Δp of the control pointer is a relatively small value, that is, when the position of the control pointer is relatively close to the reference position of the icon, a given change in the deviation Δp of the control pointer results in a large change in the displacement amount Δc of the cursor. When the deviation Δp of the control pointer is a relatively large value, that is, when the position of the control pointer is relatively distant from the reference position of the icon, the given change in the deviation Δp of the control pointer results in a small change in the displacement amount Δc of the cursor. Alternatively, the displacement amount Δc of the cursor may be calculated in the following way. When the deviation Δp is a relatively small value, the given change in the deviation Δp of the control pointer results in a small change in the displacement amount Δc of the cursor. When a value of the deviation Δp is relatively large, the given change in the deviation Δp of the control pointer results in a large change in the displacement amount Δc of the cursor.

At S160, the controller 12 draws information about the operation direction by using the cursor, based on the value θ of the operation direction calculated at S140 and the displacement amount Δc of the cursor calculated at S150. More specifically, when the controller 12 employs the movement of the cursor as a display manner for presenting the information about the operation direction, the cursor is drawn at a position that is located the displacement amount Δc apart from the reference position in a direction determined by the value θ of the operation direction. In the above, the reference position may be set at a concentric center of the icon on the operation screen. Alternatively, when the employed display manner for presenting the information about the operation direction is other than the movement of the cursor, a direction of the change in the visual presentation may be determined based on the value θ of the operation direction, and the level of the visual presentation may be determined based on the displacement amount Δc. More specific examples of modification to the display manner will be described later.

After the cursor is drawn at S160, the procedure returns to S100. The controller 12 repeatedly performs the processes S100 to S160, thereby displaying a visual presentation indicative of an operation direction by moving the cursor in accordance with the user manipulation on the manipulation device 14 that inputs the instruction of the operation direction. When the controller 12 determines at S110 that the position of the control pointer is outside the predetermined coordinate range associated with a target icon (i.e., the icon in the selection state), the determination “NO” is made at S100, and the procedure proceeds to S170. At S170, the controller 12 stop displaying the cursor in association with the target icon, and the operation direction displaying processes directed to the target icon are ended. In this case, because the position of the control pointer is moved to an outside of the predetermined coordinate range associated with the target icon, the controller 12 stops the target icon from being in the selection state, that is, the controller 12 puts the target icon in the non-selection state and puts the destination icon in the selection state. In the above, the destination icon is an icon located in a direction corresponding to the operation direction.

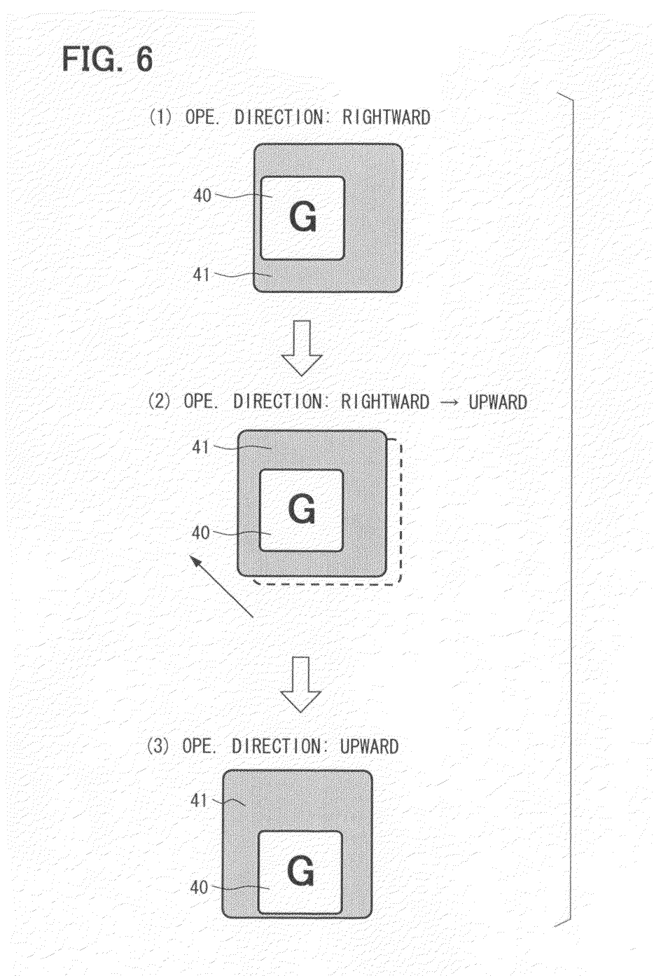

FIG. 6 illustrates one example of the display manner of the cursor for the following case. The operation direction is changed at a time when the visual presentation indicative of the operation direction is being displayed by the movement of the cursor. In FIG. 6, it is assumed that the manipulation on the manipulation knob 18 instructs a rightward operation direction and then instructs a change in the operation direction from the rightward operation direction to an upward operation direction.

At a stage (1) in FIG. 6, a rightward direction is inputted as the operation direction, and the cursor 41 is displayed rightward relative to the icon 40 in the selection state. At a stage (2) in FIG. 6, the operation direction is changed from the rightward direction to the upward direction, and the cursor 41 starts moving upward and returning leftward. At a stage (3) in FIG. 6, a certain period of time has elapsed after the change in the operation direction to the upper direction, and the cursor 41 has finished returning to the neutral position in the X axis direction. Moreover, the cursor 41 is moved only upward. As can be seen from the above, in response to the change in the operation direction, the cursor 41 is not abruptly pulled back to the original position (i.e., neutral position) but the cursor 41 follows the change in the operation direction in a soft movement manner. Thus, the remote control system can provide high operability which is not uncomfortable or strange for user.

(Modifications)

Modification examples of the remote control system will be described below.

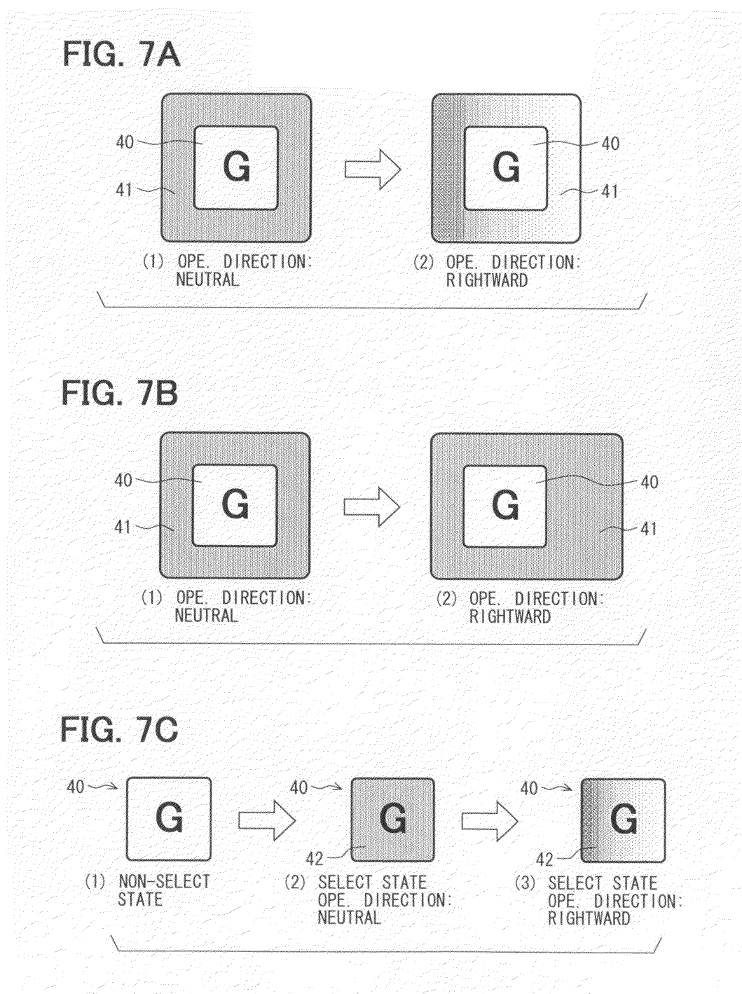

FIG. 7A illustrates an example that can be described as follows. In order to visually indicate the operation direction inputted via the manipulation device 14, the controller 12 changes color or brightness of the cursor 41, which is displayed in association with the icon 40 in the selection state. At a stage (1) in FIG. 7A, the manipulation knob 18 of the manipulation device 14 is in the neutral position. Thus, the operation direction is neutral. In the above case, the cursor 41 is drawn in a default drawing pattern (e.g., single color).

At a stage (2) in FIG. 7A, the manipulation knob 18 of the manipulation device 14 is manipulated in the rightward direction. Thus, the operation direction is a rightward direction. In this case, the drawing pattern of the cursor 41 is changed into a gradient pattern in which the color or brightness is continuously changed in a left-to-right direction. For example, the intensity of brightness may be continuously changed from the dark to right in the left-to-right direction. In the above, the gradient strength (i.e., level) of the gradient pattern may changed depending on the magnitude of the deviation Δp of the controller pointer from the reference position of the icon. The gradient pattern may be displayed as a stepwise change or a partial change in color or brightness of the cursor 41 in the operation direction.

FIG. 7B illustrates an example that can be described as follows. In order to visually indicate the operation direction inputted via the manipulation device 14, the controller 12 changes shape of the cursor 41, which is displayed in association with the icon 40 in the selection state. At a stage (1) of FIG. 7B, the manipulation knob 18 of the manipulation device 14 is in the neutral position. Thus, the operation direction is neutral. In this case, the cursor 41 is drawn to have a default shape, which is similar to the shape of the icon for example.

At a stage (2) in FIG. 7B, the manipulation knob 18 of the manipulation device 14 is manipulated in the rightward direction. Thus, the operation direction is rightward. In this case, the cursor 41 expands rightward in accordance with the operation direction. In the above, a degree of expansion of the cursor 41 may be changed depending on the magnitude of the deviation Δp of the control pointer from the reference position of the icon. Alternatively, the shape of the cursor 41 may be changed in the following ways. The cursor 41 may be deformed and sharpened (i.e., have a sharp edge) in the operation direction, or the cursor 41 may be deformed into an arrow that points in the operation direction.

FIG. 7C illustrates an example that can be described as follows. An image of the icon 40 in the selection state is displayed highlightedly. A display manner of highlighting the image of the icon 40 is changed in order to visually indicate the operation direction inputted via the manipulation device 14. At a stage (1) in FIG. 7C, the icon 40 is in the non-selection state and is drawn in a default drawing pattern (e.g., drawn in single color).

At a stage (2) in FIG. 7C, the icon 40 is in the selection state and the manipulation knob 18 of the manipulation device 14 is in the neutral position. In this case, the icon 40 in the selection state is displayed highlightedly. The icon 40 has highlighting display 42. Thus, the icon 40 in the selection state is distinguishable from other icons in the non-selection state.

At a stage (3) in FIG. 7C, the manipulation knob 18 of the manipulation device 14 is manipulated in the rightward direction. Thus, the operation direction is rightward. In this case, a drawing pattern of the highlighting display 42 of the icon 40 in the selection state is changed into a gradient pattern in which the color or brightness is continuously changed in the left-to-right direction. For example, the brightness is changed from the dark to the light in the left-to-right direction. In the above, the gradient strength of the gradient pattern may be changed depending on the magnitude of the deviation Δp of the controller pointer from the reference position of the icon. Alternatively, the gradient pattern of the highlighting display 42 may be a stepwise change or a partial change in color or brightness of the cursor 41 in the operation direction. Alternatively, the highlighting display 42 of the icon 40 in the selection state may be moved or deformed thereby to visually indicate the operation direction.

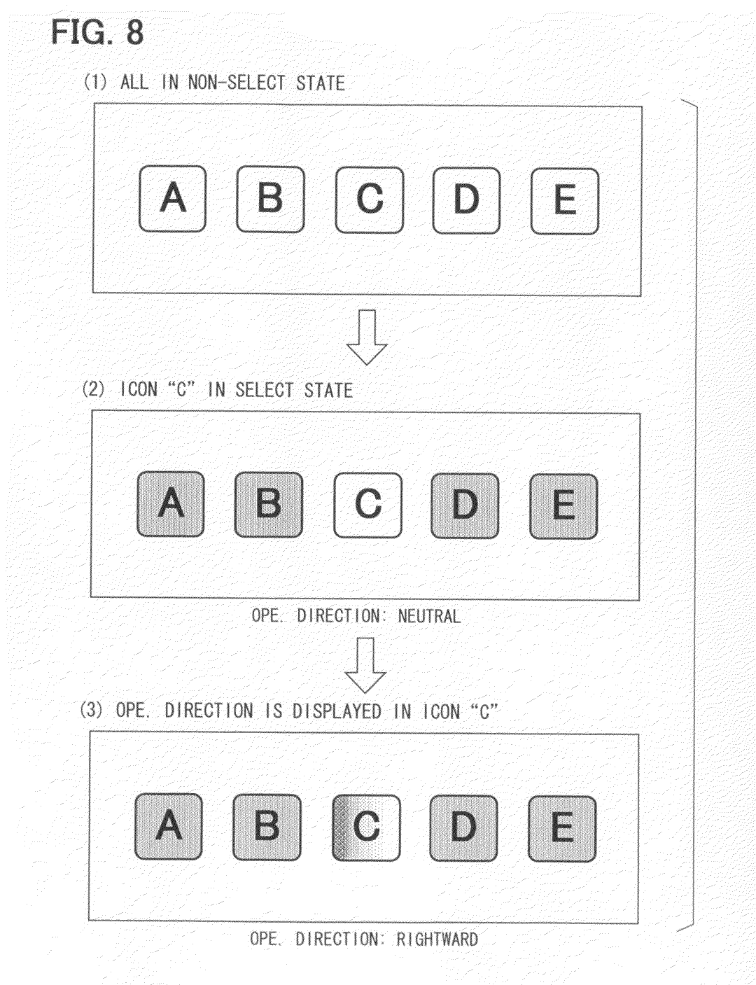

FIG. 8 illustrates an example that can be described as follows. A display manner of an icon in the non-selection state (different from the icon in the selection state) is changed so that the icon in the selection state is distinguishable. At a stage (1) in FIG. 8, each of five icons A, B, C, D and E is in the non-selection state and is drawn in the default drawing pattern.

At a stage (2) in FIG. 8, the icon C is in the selection state and other icons A, B, D, E are in the non-selection state. Further, the manipulation knob 18 of the manipulation device 14 is in the neutral position. In this case, the colors of the icons A, B, D, E are toned down except for the icon C in the selection state. Thereby, the icon C in the selection state is highlighted in a relative manner, and is distinguishable from the other icons A, B, D, E in the non-selection state.

At a stage (3) in FIG. 8, the manipulation knob 18 of the manipulation device 14 is manipulated in the rightward direction. Thus, the operation direction is rightward. In this case, the drawing pattern of the icon C in the selection state is changed into a gradient pattern in which the color or brightness is continuously changed in the left-to-right direction. For example, the brightness is changed from the dark to the light. In the above, the gradient strength of the gradient pattern may be changed depending on the magnitude of the deviation Δp of the controller pointer from the reference position of the icon. Alternatively, the gradient pattern may be a stepwise change or a partial change in color or brightness of the icon C in the operation direction.

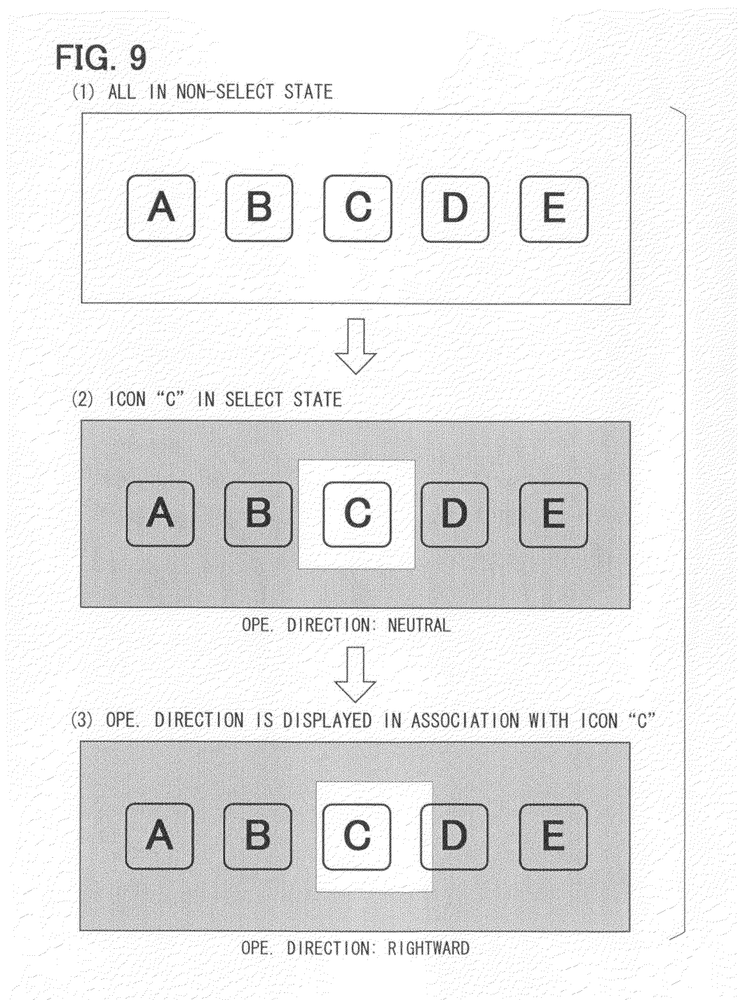

FIG. 9 illustrates an example that can be described as follows. A display manner of regions other than a periphery of the icon in the selection state is changed so that the icon in the selection state is distinguishable. At a stage (1) in FIG. 9, each of five icons A, B, C, D and E is in the non-selection state and is drawn in the default drawing pattern.

At a stage (2) in FIG. 9, the icon C is in the selection state and other icons A, B, D, E are in the non-selection state. Further, the manipulation knob 18 of the manipulation device 14 is in the neutral position. In this case, regions other than a periphery of the icon C in the selection state are toned down. Thereby, the icon C in the selection state is highlighted in a relative manner, and is distinguishable from the other icons A, B, D, E in the non-selection state.

At a stage (3) in FIG. 9, the manipulation knob 18 of the manipulation device 14 is manipulated in the rightward direction. Thus, the operation direction is rightward. The highlighted regions surrounding the icon C in the selection state are moved rightward in accordance with the operation direction. In the above, an amount of the movement of the highlighted regions may be changed depending on the magnitude of the deviation Δp of the controller pointer from the reference position of the icon. Alternatively, the color, brightness or shape of the highlighted regions may be changed in order to visually indicate the operation direction.

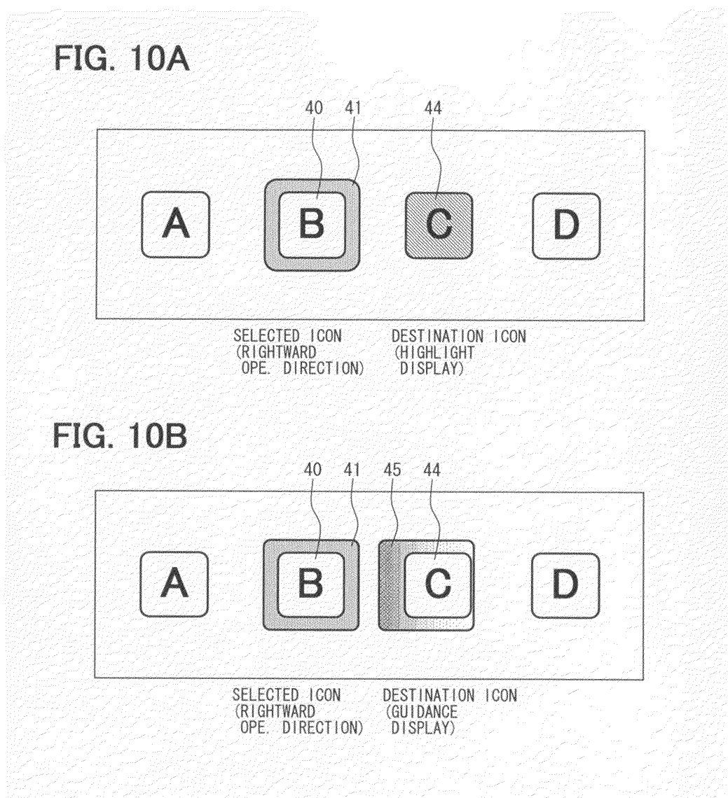

FIGS. 10A and 10B illustrate methods for visually presenting the operation direction. In the methods in FIGS. 10A and 10B, a highlighting display is provided to the destination icon, which is located in the operation direction from the position of the icon in the selection state. FIG. 10A illustrates an example that can be described as follows. The cursor 41 is displayed in association with the icon B in the selection state, so that the icon B in the selection state is distinguishable. When the manipulation knob 18 of the manipulation device 14 is manipulated in the rightward direction, the controller 12 highlights the drawing pattern of the icon C (44), which is the first next icon on the right of the icon B (40). Accordingly, a user can visually recognize in which direction the cursor is about to move in response to his or her present manipulation.

FIG. 10B illustrates an example that can be described as follows. A guidance display mark is displayed in association with the destination icon, which is the icon C in the case of FIG. 10B. A display manner of the guidance display mark is changed in order to visually indicate the operation direction. When the manipulation knob 18 of the manipulation device 14 is manipulated in the rightward direction, the guidance display mark 45 is displayed in association with the destination icon, which is the icon C (44) and which is the first next icon on the right of the icon B (40) in the selection state. The guidance display mark 45 is drawn in the following way. The guidance display mark 45 is displaced leftward toward the icon B (40) in the selection state. The guidance display mark 45 has therein a gradient that is a continuous change in color or bright in the right-to-left direction along the operation direction. In the above, the gradient strength or displacement amount of the guidance display mark 45 may be changed depending on the magnitude of the deviation Δp of the controller pointer from the reference position of the icon 40 in the selection state.

(Advantages)

Advantages of the above remote control system include the following.

The cursor or the highlighting display is displayed so that the icon in the selection state is distinguished. By using this cursor or highlighting display, the operation direction is visually presented. Thus, prior to the shift of the selection state to the destination icon, it is possible to visually inform to a user in which direction the selection state is about to be shifted in accordance with the input of his or her instruction about the operation direction. As a result, a user can recognize in which direction the cursor is about to move in response to his or her manipulation. Therefore, operability of the remote control system is improved. If the inputted operation direction is different from a user's intended direction, a user can be aware of his or her wrong operation through visually recognizing the change in display manner of the cursor or the highlighting display before the cursor is moved to an unintended icon. Thus, a user can promptly correct his or her operation before the cursor is moved to an unintended icon. Moreover, unlike a pointer which is displayed to consciously trace or track a result of user manipulation for the input of an operation direction, the visual presentation indicative of the operation direction is displayed in the vicinity of the icon in the selection state only when the instruction about the operation direction is inputted. Therefore, as compared to the pointer, it is possible to reduce a time for a user to gaze the operation screen and it is possible to lower the user's operation burden.

Depending on an amount of manipulation on the manipulation device (more specifically, the deviation Δp of the control pointer), it is possible to alter the level of a change in various visual presentations such as the movement of the cursor or the highlighting display, the change in color or brightness of the cursor or the highlighting display, the deformation of the cursor or the highlighting display, and the like. Therefore, a user can visually recognize how much operation amount is further needed to move the selection state to the destination icon. Operability is therefore improved.

When the highlighting display or the guidance display mark indicative of the operation direction is provided to the destination icon, it is possible to obtain the above-described advantages.

(Aspects)

According to a first aspect of the present disclosure, a display control device for a remote control device includes a connection means and a display control means. The connection means is connected with a display device and a remote control device. The display device is configured to display an operation screen for accepting an operation directed to a control target apparatus. Multiple icons are arranged on the operation screen. The remote control device is spaced apart from the display device and is manipulatable by a user. The display control means is configured to perform display control in manners including the followings. The display control means receives an input of an instruction about an operation direction from the remote control device, performs processing according to the input, and causes the display device to display a result of the processing on the operation screen according to the input. The display control means displays an identification display mark on the operation screen, so that (i) the identification display mark indicates that one icon of the multiple icons, the one icon being presently selected, is in a selection state and (ii) the identification display mark is displayed in association with the one icon in the selection state. When the display control means receives the input of the instruction about the operation direction while the one icon is being in the selection state, the display control means displays a visual presentation indicative of the operation direction on the operation screen by making a change in display manner of the identification display mark, with the identification display mark being displayed in association with the one icon in the selection state. When an operation amount of the operation direction reaches a condition for moving the selection state from the one icon, the display control means stops the one icon from being in the selection state and stops displaying the identification display mark in association with the one icon.

According to the above display control device, before the selection state is shifted from the one icon to a destination icon, it is possible to visually inform to a user in which direction the selection state is about to be shifted in accordance with the input of the instruction about the operation direction. As a result, a user can recognize in which direction the identification display mark (e.g., cursor) is about to move in response to his or her manipulation on the remote control device. Operability of the remote control device is improved. Even if the inputted operation direction is different from a user's intended direction, a user can be aware of his or her wrong operation through recognizing the change in display manner of the identification display mark before the selection state is shifted to an unintended icon. Thus, a user can promptly correct his or her operation.

Moreover, unlike a pointer which is continuously displayed to continuously track or trace a result of a user's manipulation for the input of the operation direction, the visual presentation indicative of the operation direction is displayed in the vicinity of the one icon in the selection state only when the instruction of the operation direction is inputted. Therefore, it is possible to reduce a time for user to gaze the operation screen and a user's operation burden, as compared to the pointer.

The above display control device may be configured such that: the display control means displays the visual presentation indicative of the operation direction by moving the identification display mark in the operation direction, with the identification display mark being displaying in association with the one icon in the selection state. Alternatively, the display control means may display the visual presentation indicative of the operation direction by changing at least one of color and brightness of the identification display mark, with the identification display mark being displayed in association with the one icon in the selection state. For example, a region on an operation direction side of the identification display may be light up or may be drawn in color standing out from its surroundings. The operation direction may be indicated using a color gradient of the identification display mark in which color or brightness is changed along the operation direction in a continuous manner or a stepwise manner. Alternatively, the display control means may displays the visual presentation indicative of the operation direction by changing shape of the identification display mark, with the identification display mark being displayed in association with the one icon in the selection state. For example, the identification display mark may be expanded or sharpened in the operation direction, or may be deformed into an arrow pointing in the operation direction.

The above display control device may be configured such that the display control means alters level of the change in display manner of the identification display mark according to level of the operation amount of the inputted operation direction. For example, the level of the change in the display manner of the identification display mark may become larger as an operation amount of the operation direction is increased after start of the input of the instruction of the operation direction. According to the above configuration, a user can visually recognize how much operation amount is further needed to move the selection state to the destination icon. Operability is improved.

The above display control device may be configured such that: the display control means highlights a periphery region of the one icon in the selection state, thereby displaying the identification display mark indicating that the one icon is in the selection state. According to this configuration, a region in which the identification display mark is allowed to be displayed is larger than an icon. Thus, the visual presentation indicative of the operation direction is advantageously well-viewable. Alternatively, the above display control device may be configured such that: the display control means (12) highlights an inside region of an image of the one icon in the selection state, thereby displaying the identification display mark indicating that the one icon is in the selection state. According to this configuration, the visual presentation indicative of the operation direction can be advantageously displayed in a small space.

According to a second aspect of the present disclosure, a display control device for a remote control device includes a connection means and a display control means. The connection means has connection with a display device and a remote control device. The display device is configured to display an operation screen for accepting an operation directed to a control target apparatus. Multiple icons are arranged on the operation screen. The remote control device is spaced apart from the display device and is manipulatable by a user. The display control means is configured to perform display control in manners including the followings. The display control means receives an input of an instruction about an operation direction from the remote control device, performs processing according to the input, and causes the display device to display a result of the processing on the operation screen according to the input. The display control means displays an identification display mark on the operation screen, so that (i) the identification display mark indicates that one icon of the multiple icons, the one icon being presently selected, is in a selection state and (ii) the identification display mark is displayed in association with the one icon in the selection state. When the display control means receives the input of the instruction about the operation direction while the one icon is being in the selection state, the display control means displays a guidance display mark indicative of a destination icon on the operation screen, so that (i) the destination icon is assigned as another one icon of the plurality of icons to correspond to the operation direction from the one icon in the selection state and (ii) the guidance display mark is displayed in association with the destination icon. When an operation amount of the inputted operation direction reaches a condition for moving the identification display mark from the one icon to the destination icon, the display controls means shifts the selection state from the one icon to the destination icon and shifts a display target of the identification display mark from the one icon to the destination icon.

According to the above display control device, before the selection state is shifted from the one icon to the destination icon, it is possible to use the guidance display mark in order to visually inform to a user in which direction the selection state is about to be shifted in accordance with the input of the instruction about the operation direction. As a result, a user can recognize in which direction the identification display mark (e.g., cursor) is about to move in response to his or her manipulation on the remote control device. Operability of the remote control device is improved. Even if the inputted operation direction is different from a user's intended direction, a user can be aware of his or her wrong operation through recognizing the change in display manner of the guidance display mark before the selection state is shifted to an unintended icon. Thus, a user can promptly correct his or her operation.

Moreover, unlike a pointer which is continuously displayed to continuously track or trace a result of a user's manipulation for the input of the operation direction, the guidance display mark indicative of the destination icon is displayed in the vicinity of the destination icon only when the instruction about the operation direction is inputted. Therefore, it is possible to reduce a time for user to gaze the operation screen and a user's operation burden, as compared to the pointer.

The above display control device may be configured such that: the display control means displays a visual presentation indicative of the operation direction by making a change in display manner of the guidance display mark, with the guidance display mark being displayed in association with the destination icon. According to this configuration, it is possible to more clearly indicate in which direction the destination icon is located.

The above display control device may be configured such that: the display control means displays the visual presentation indicative of the operation direction by moving the guidance display mark from position of the destination icon toward the one icon in the selection state, with the guidance display mark being displayed in association with the destination icon. Alternatively, the display control means may, display the visual presentation indicative of the operation direction by changing at least one of color and brightness of the guidance display mark, with the guidance display mark being displayed in association with the destination icon. For example, only a part of the guidance display mark facing the one icon in the selection state may be light up or may be drawn in color standing out from its surroundings. The operation direction may be indicated using a color gradient of the guidance display mark. The color gradient may be a continuous or stepwise change in color or brightness of the guidance display mark in a direction toward the icon in the selection state. Alternatively, the display control device may be configured such that: the display control means displays the visual presentation indicative of the operation direction by changing shape of the guidance display mark, with the guidance display mark being displayed in association with the destination icon. For example, the guidance display mark may be expanded or sharpened toward the icon in the selection state.

The display control device may be configured such that: the display control means alters level of the change in display manner of the guidance display mark according to level of the operation amount of the inputted operation direction. For example, the level of the change in the display manner of the guidance display mark may become larger as an operation amount of the operation direction is increased after the start of the input of the instruction of the operation direction. According to this configuration, a user can visually recognize how much operation amount is further needed to move the selection state to the destination icon. Operability is improved.

The above display control device may be configured such that: the display control means highlights a periphery region of the destination icon, thereby displaying the guidance display mark indicative of the destination icon. According to this configuration, a region in which the guidance display mark is allowed to be displayed is larger than an icon, and the visual presentation indicative of the operation direction is advantageously well-viewable. Alternatively, the display control device may be configured such that: the display control means highlights an inside region of an image of the destination icon, thereby displaying the guidance display mark indicative of the destination icon. According to this configuration, the visual presentation indicative of the operation direction can be advantageously displayed in a small space.

While the invention has been described above with reference to various embodiments thereof, it is to be understood that the invention is not limited to the above described embodiments and constructions. The invention is intended to cover various modifications and equivalent arrangements.

Further, each or any combination of procedures, processes, steps, or means explained in the above may be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units may be included in a software program, which is contained in a computer-readable storage media or is installed in a computer via a communications network.

What is claimed is:

1. A display control device for a remote control device, the display control device comprising:
a connection means for having connection with a display device and a remote control device, wherein the display device is configured to display an operation screen for accepting an operation directed to a control target apparatus, wherein a plurality of icons is arranged on the operation screen, wherein the remote control device is spaced apart from the display device and is manipulatable by a user; and
a display control means for performing display control, such that:
the display control means receives an input of an instruction about an operation direction from the remote control device, performs processing according to the input, and causes the display device to display a result of the processing on the operation screen according to the input;
the display control means displays an identification display mark on the operation screen, so that
(i) the identification display mark indicates that one icon of the plurality of icons, the one icon being presently selected, is in a selection state and
(ii) the identification display mark is displayed in association with the one icon in the selection state;
when the display control means receives the input of the instruction about the operation direction while the one icon is being in the selection state, the display control means displays a visual presentation indicative of the operation direction on the operation screen by making a change in display manner of the identification display mark, with the identification display mark being displayed in association with the one icon in the selection state; and
when an operation amount of the inputted operation direction reaches a condition for moving the selection state of the one icon, the display control means stops the one icon from being in the selection state and stops displaying the identification display mark in association with the one icon.

2. The display control device according to claim 1, wherein:
the display control means alters level of the change in display manner of the identification display mark according to level of the operation amount of the inputted operation direction.

3. The display control device according to claim 1, wherein:
the display control means displays the visual presentation indicative of the operation direction by moving the identification display mark in the operation direction, with the identification display mark being displaying in association with the one icon in the selection state.

4. The display control device according to claim 1, wherein:
the display control means displays the visual presentation indicative of the operation direction by changing at least one of color and brightness of the identification display mark, with the identification display mark being displayed in association with the one icon in the selection state.

5. The display control device according to claim 1, wherein:
the display control means displays the visual presentation indicative of the operation direction by changing shape of the identification display mark, with the identification display mark being displayed in association with the one icon in the selection state;

6. The display control device according to claim 1, wherein:
the display control means highlights a periphery region of the one icon in the selection state, thereby displaying the identification display mark indicating that the one icon is in the selection state.

7. The display control device according to claim 1, wherein:
the display control means highlights an inside region of an image of the one icon in the selection state, thereby displaying the identification display mark indicating that the one icon is in the selection state.

8. A display control device for a remote control device, the display control device comprising:
a connection means for having connection with a display device and a remote control device, wherein the display device is configured to display an operation screen for accepting an operation directed to a control target apparatus, wherein a plurality of icons is arranged on the operation screen, wherein the remote control device is spaced apart from the display device and is manipulatable by a user; and
a display control means for performing display control, such that:
the display control means receives an input of an instruction about an operation direction from the remote control device, performs processing according to the input, and causes the display device to display a result of the processing on the operation screen according to the input;
the display control means displays an identification display mark on the operation screen, so that
(i) the identification display mark indicates that one icon of the plurality of icons, the one icon being presently selected, is in a selection state and
(ii) the identification display mark is displayed in association with the one icon in the selection state;
when the display control means receives the input of the instruction about the operation direction while the one icon is being in the selection state, the display control means displays a guidance display mark indicative of a destination icon on the operation screen, so that
(i) the destination icon is assigned as another one icon of the plurality of icons to correspond to the operation direction from the one icon in the selection state and
(ii) the guidance display mark is displayed in association with the destination icon; and
when an operation amount of the inputted operation direction reaches a condition for moving the identification display mark from the one icon to the destination icon, the display controls means shifts the selection state from the one icon to the destination icon and shifts a display target of the identification display mark from the one icon to the destination icon.

9. The display control device according to claim 8, wherein:
the display control means displays a visual presentation indicative of the operation direction by making a change in display manner of the guidance display mark, with the guidance display mark being displayed in association with the destination icon.

10. The display control device according to claim 9, wherein:
the display control means alters level of the change in display manner of the guidance display mark according to level of the operation amount of the inputted operation direction.

11. The display control device according to claim 9, wherein:
the display control means displays the visual presentation indicative of the operation direction by moving the guidance display mark from position of the destination icon toward the one icon in the selection state, with the guidance display mark being displayed in association with the destination icon.

12. The display control device according to claim 9, wherein:
the display control means displays the visual presentation indicative of the operation direction by changing at least one of color and brightness of the guidance display mark, with the guidance display mark being displayed in association with the destination icon.

13. The display control device according to claim 9, wherein:
the display control means displays the visual presentation indicative of the operation direction by changing shape of the guidance display mark, with the guidance display mark being displayed in association with the destination icon.

14. The display control device according to claim 8, wherein:
the display control means highlights a periphery region of the destination icon, thereby displaying the guidance display mark indicative of the destination icon.

15. The display control device according to claim 8, wherein:
the display control means highlights an inside region of an image of the destination icon, thereby displaying the guidance display mark indicative of the destination icon.
